(19) United States
(12) Patent Application Publication
(10) Pub. No.: US 2007/0022528 A1
(43) Pub. Date: Feb. 1, 2007

(54) Combination handheld shower and stationary showerhead

(76) Inventor: Christopher Jon Gilbert, Moreland Hills, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/194,410

(22) Filed: Aug. 1, 2005

(51) Int. Cl. A47K 3/022; A47K 3/34; A47K 3/36

(52) U.S. Cl. 4/615

(57) ABSTRACT

A showerhead is disclosed having a stationary portion and a movable portion. The movable portion is operable to dock at least partially within the stationary portion to create an integral appearance. Both the stationary portion and movable portion have at least one spray nozzle disposed therein. The stationary portion and movable portion are operable to simultaneously deliver water from their spray nozzles.

### BACKGROUND

The present invention relates to showerheads and more specifically to a combination handheld shower and stationary showerhead.

Showerheads generally come in two types: handheld showers and stationary showerheads. Each type is independent from the other.

Stationary showerheads, having spray nozzles, are attached to an end of a shower arm which extends from a wall. The shower arm provides a water path from a water supply to the showerhead. The stationary showerhead when installed is fixed relative to the shower arm. The showerhead may be able to rotate to offer different spray patterns or even pivot in a ball socket manner to direct the water flowing from the spray nozzles to a desired location in the shower. However, the showerhead is not designed to be removed from the shower arm during use so that the user may direct water flow to precise locations from varying directions.

Handheld showers have a hose that attaches, like showerheads, to the end of the shower arm. Handheld showers have a docking device that is also attached to the end of the shower arm. The handheld shower may be docked in the docking device so that it acts like a showerhead or it may be undocked from the docking device. When undocked, the handheld shower is held by the user and therefore may be moved by the user to any position in which the user wishes to hold the handheld shower. The hose provides a waterway for water to travel from the shower arm to the handheld shower.

### SUMMARY

A showerhead is disclosed having a stationary portion and a movable portion. The movable portion is operable to dock at least partially within the stationary portion to create an integral appearance. Both the stationary portion and movable portion have at least one spray nozzle disposed therein. The stationary portion and movable portion are operable to simultaneously deliver water from their spray nozzles.

Numerous other advantages and features of the present invention will become readily apparent from the following detailed description of the invention and the embodiments thereof, from the claims and from the accompanying drawings.

### BRIEF DESCRIPTION OF THE DRAWINGS

The invention as well as embodiments and advantages thereof are described below in greater detail, by way of example, with reference to the drawings in which:

FIG. 1 is a front elevational view of a showerhead in accordance with an embodiment of the present invention;

FIG. 2 is a right side elevational view of the showerhead of FIG. 1;

FIG. 3 is a right side elevational view of the showerhead of FIG. 1 in use in an undocked position;

FIG. 4 is a perspective view of the showerhead of FIG. 1 in an undocked position; and

FIG. 5 is a right side cross-sectional view of the stationary portion and a right side elevational view of the movable portion of the showerhead of FIG. 1 in a docked position.

### DETAILED DESCRIPTION

While this invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

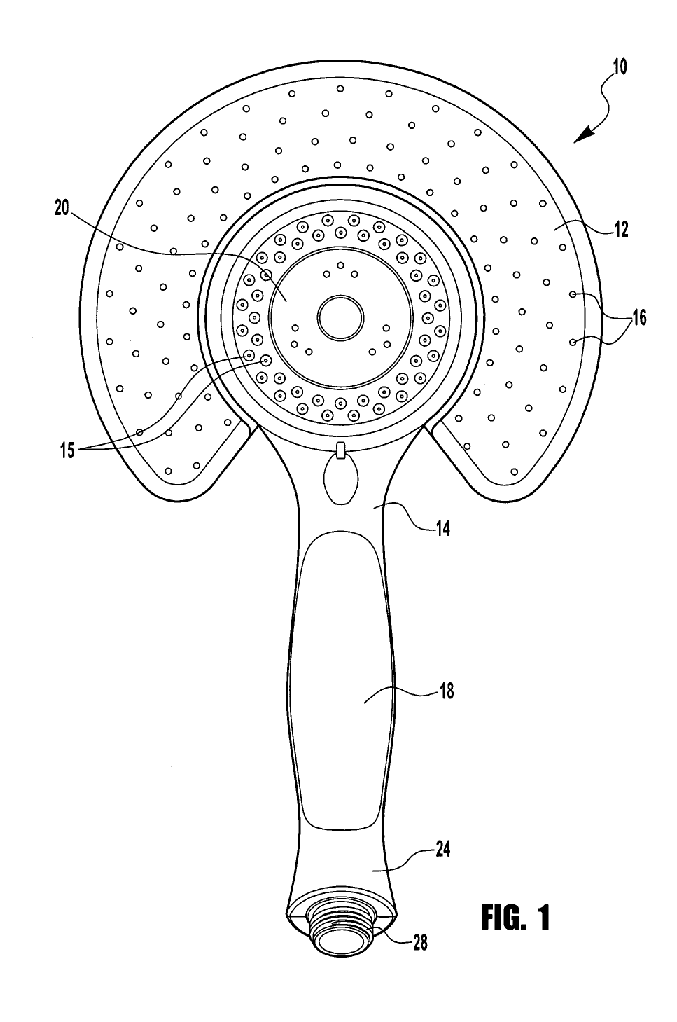

FIG. 1 shows a front view of an embodiment of a showerhead 10. The showerhead 10 includes a stationary member 12 and a movable member 14. The movable member 14 and stationary member 12 each have a plurality of spray nozzles 15, 16 (respectively) through which water (or other fluid) may pass. The stationary member 12 and the movable member 14 may each discretely pass fluid at a rate of up to 2.5 gallons/minute. The movable member 14 includes a handle 18 and a sprayhead 20. The sprayhead 20 of the movable member 14 docks within the stationary member 12 to create an integral appearance. In other words, the combination of the stationary member 12 and the movable member 14 creates an appearance to a user of a single showerhead as opposed to having the movable member 14 dock at a completely different location outside the stationary member 12.

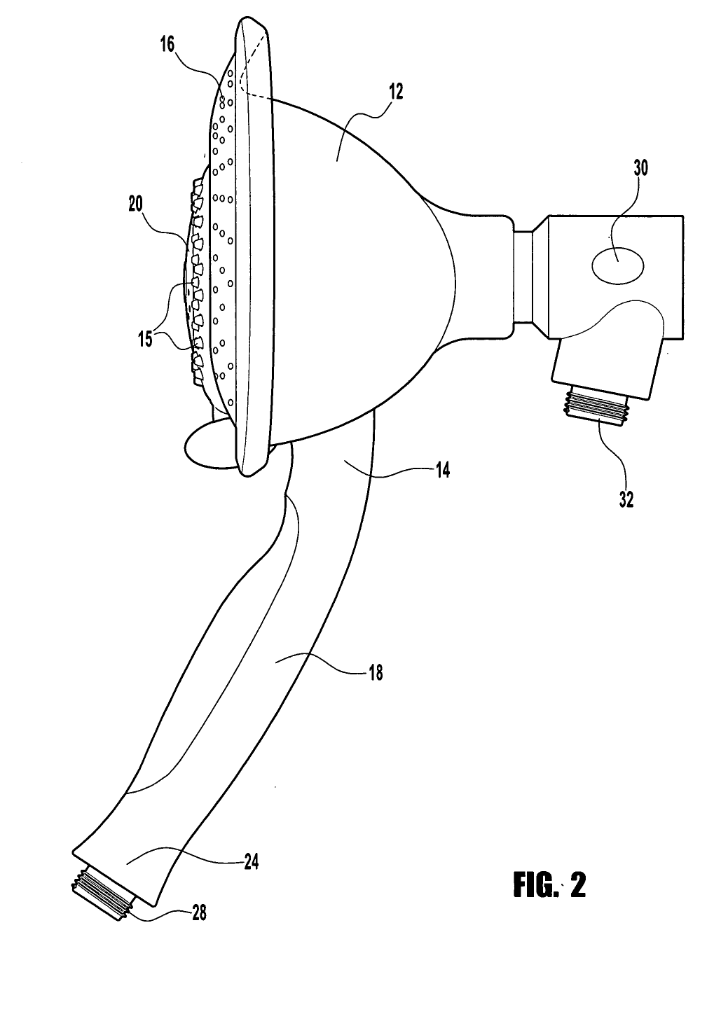

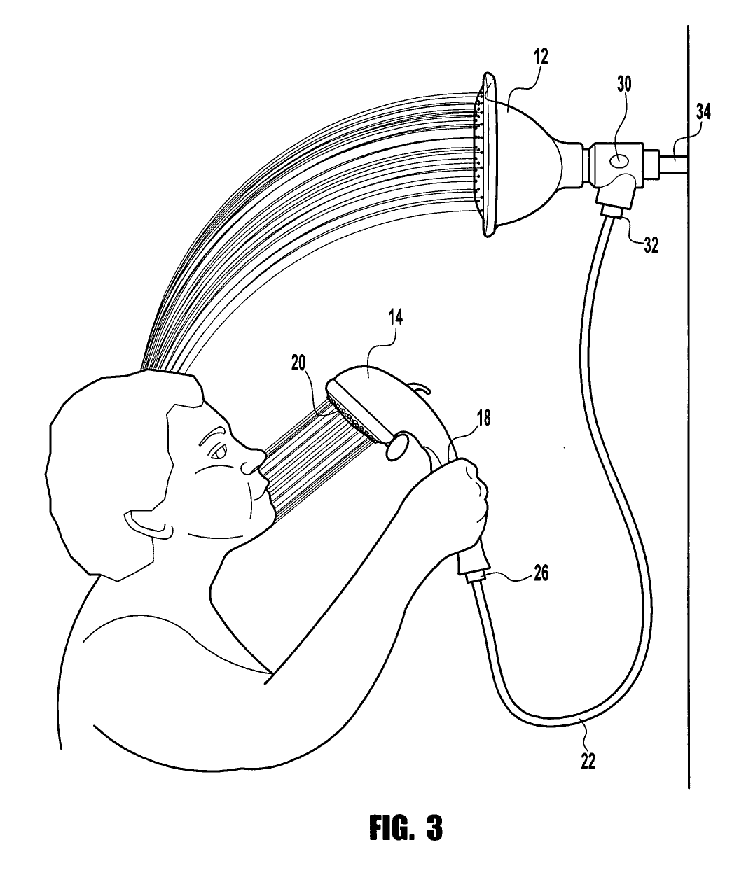

Referring also to FIGS. 2-3, like a handheld shower, the movable member 14 includes a flexible hose 22 attached to a lower portion 24 of the movable member 14. The hose 22 can attach to the lower portion 24 in a variety of ways including, but not limited to, a threaded nut 26 which screwedly threads onto an outlet end 28 of the movable member 14.

The stationary member 12 and the movable member 14 are attached to a diverter 30. The flexible hose 22 connects to an outlet 32 of the diverter 30. The diverter 30 is attached to a water source pipe 34. The water source pipe 34 is a waterway through which water is supplied to the diverter 30. The diverter 30 directs water from the water source pipe 34 to the stationary member 12 and the movable member 14. The diverter 30 may be any of a number of different types of diverters know in the industry. For example, the diverter 30 shown in FIGS. 2-3 is a three-way toggle diverter. When water is directed to the stationary member 12, the water flows through an internal waterway (not shown) of the stationary member 12 and out through the spray nozzles 16. When water is directed to the movable member 14, the water flows through the flexible hose 22, through an internal waterway (not shown) of the movable member 14, and out through the spray nozzles 15.

The diverter 30 controls where the water flowing from the water source pipe 34 is allowed to flow. Since the diverter 30 of FIGS. 2-3 is a three-way diverter, the diverter 30 can direct the incoming water in three different ways. As will be explained below, depending on the setting of the diverter 30, water can flow to either or both the stationary member 12 and movable member 14.

The first way is to permit the water to flow to both the internal waterway of the stationary member 12 and to the flexible hose 22. This allows water to flow from the nozzles 16 of the stationary member 12 while simultaneously flowing from the nozzles 15 of the movable member 14. In other words, in this first mode, water is permitted to flow from the movable member 14 and stationary member 12 at the same time.

The second way that the diverter 30 can direct water is to prevent water from flowing to the flexible hose 22 and allow water to flow to the internal waterway of the stationary member 12. In this second mode, the water is permitted to flow from the nozzles 16 of the stationary member 12 but not from the nozzles 15 of the movable member 14.

The third way that the diverter 30 can direct water is to prevent water from flowing to the internal waterway of the stationary member 12 and allow water to flow to the flexible hose 22. Converse to the second mode, in the third mode, water is permitted to flow from the nozzles 15 of the movable member 14 but not from the nozzles 16 of the stationary member 12.

The showerhead 10 also includes an attachment device 37. The attachment device 37 is a mechanism that allows the movable member 14 to dock at least partially within the stationary member 12 to create an integral appearance. That is, the combination of the stationary member 12 and the movable member 14, when docked, has an integral appearance.

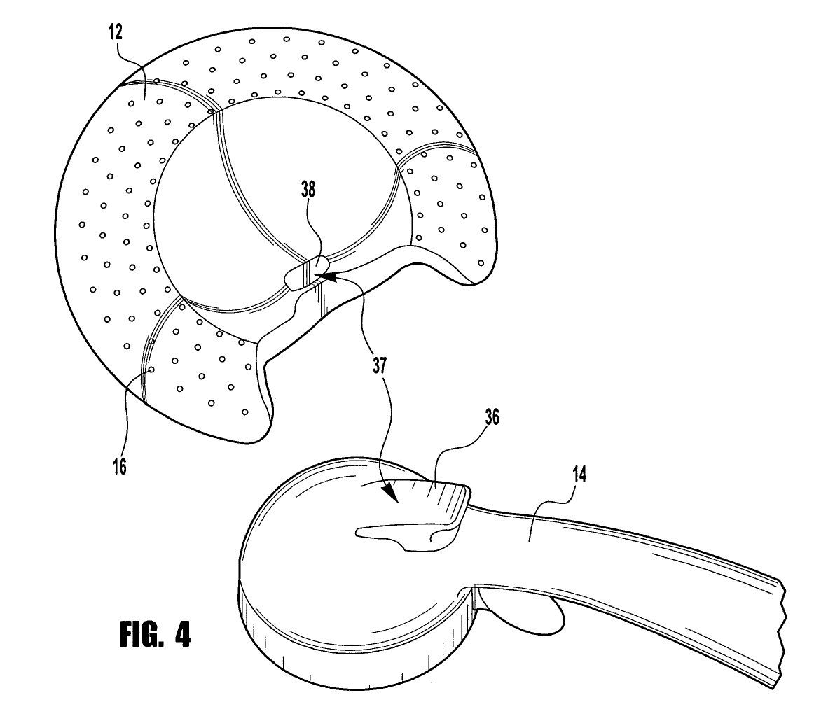

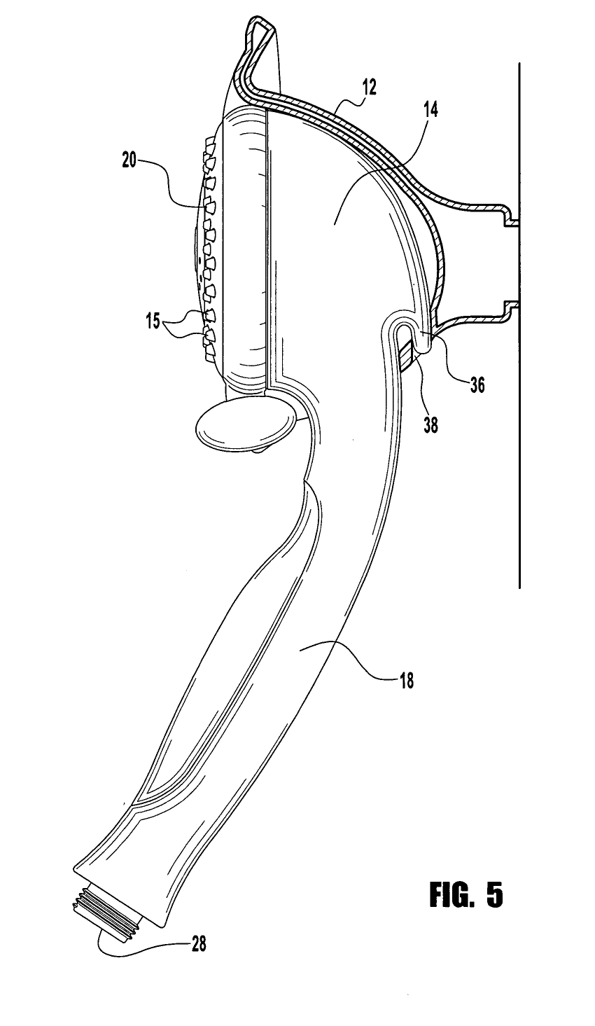

The attachment device 37 as shown in FIGS. 4-5 includes a hook member 36 and a docking aperture 38. The hook member 36, in the showerhead of FIGS. 4-5, projects from the back of the movable member 14. The docking aperture 38 is an opening in the stationary member 12 sized to allow the hook member 36 to fit snuggly therein. Furthermore, the shapes of the hook member 36 and docking aperture 38 are designed such that, when docked, the movable member 14 sits firmly within the stationary member 12. When undocked, the movable member 14 is operable to move as directed by a user, much like any other handheld shower. Although the attachment device 37 of FIGS. 4-5 includes a hook member 36 and a docking aperture 38, other types of attachment devices are also possible. For example, the attachment device 37 can be magnetic such that the movable member 14 is docked using a magnetic force.

The shape of the movable member 14 corresponds to the shape of the stationary member 12 such that, when docked, the combination of the stationary member 12 and the movable member 14 has an integral appearance. The shapes of the movable member 14 and stationary member 12 may vary. For example, as shown in the FIGS., the movable member 14 may be ring shaped and, when docked, the stationary member 12 sits within the ring shape. Other shapes are possible so long as the combination of the stationary member 12 and movable member 14 has an integral appearance.

The above description of some of the embodiments of the present invention has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. A showerhead comprising:
a stationary portion having at least one spray nozzle; and
a movable portion having at least one spray nozzle;
wherein said movable portion is operable to dock at least partially within said stationary portion to create an integral appearance.

2. The showerhead of claim 1, wherein said stationary portion and said movable portion are operable to simultaneously deliver water from their spray nozzles.

3. The showerhead of claim 1, further comprising a diverter operable to selectively allow water to flow solely to said stationary portion, solely to said movable portion and simultaneously to both said stationary portion and said movable portion.

4. The showerhead of claim 2, wherein said stationary portion has a flow rate of up to 2.5 gallons/minute.

5. The showerhead of claim 4, wherein said movable member has a flow rate of up to 2.5 gallons/minute independent of the flow rate of said stationary portion.

6. The showerhead of claim 1, further comprising an attachment mechanism operable to dock said movable portion within said stationary portion.

7. The showerhead of claim 6, wherein said attachment mechanism is a hooking mechanism.

8. The showerhead of claim 7, wherein said hooking mechanism includes a hook member on said movable portion and an opening on said stationary portion, said hook member being engagable with said opening.

9. The showerhead of claim 6, wherein said attachment mechanism is a magnetic mechanism.

10. The showerhead of claim 6, wherein said attachment mechanism is a snap mechanism.

11. A showerhead comprising:
a stationary portion having at least one spray nozzle;
a movable portion having at least one spray nozzle; and
an attachment mechanism operable to dock said movable portion at least partially within said stationary portion;
wherein said stationary portion and said movable portion are operable to simultaneously deliver water from their spray nozzles.

12. The showerhead of claim 11, further comprising a diverter operable to selectively allow water to flow solely to said stationary portion, solely to said movable portion and simultaneously to both said stationary portion and said movable portion.

13. The showerhead of claim 11, wherein said stationary portion has a flow rate of up to 2.5 gallons/minute.

14. The showerhead of claim 13, wherein said movable member has a flow rate of up to 2.5 gallons/minute independent of the flow rate of said stationary portion.

15. The showerhead of claim 11, wherein said attachment mechanism is a hooking mechanism.

16. The showerhead of claim 15, wherein said hooking mechanism includes a hook member on said movable portion and an opening on said stationary portion, said hook member being engagable with said opening.

17. The showerhead of claim 11, wherein said attachment mechanism is a magnetic mechanism.

18. The showerhead of claim 11, wherein said attachment mechanism is a snap mechanism.

19. A showerhead comprising:
a stationary portion having at least one spray nozzle; and
a docking portion operable to dock a handheld shower;
wherein said docking portion is disposed within said stationary portion.

20. A handheld shower comprising:
a body portion having at least one spray nozzle;
wherein said body portion is operable to be docked to a docking portion disposed within a stationary showerhead, said stationary showerhead having at least one spray nozzle.
